(19) United States
(12) Patent Application Publication
(10) Pub. No.: US 2026/0362063 A1
(43) Pub. Date: Nov. 12, 2026

(54) HEARING AID CONFIGURED FOR STREAMING CONNECTIONS, AND METHOD OF OPERATING A HEARING AID

(71) Applicant: Oticon A/S, Smørum (DK)

(72) Inventors: Juan Manuel VÖLKER, Smørum (DK); Peter RØNBERG, Smørum (DK); Anida MEMIC, Smørum (DK); Angela JOSUPEIT, Smørum (DK); Mehran SADRI, Smørum (DK); Patrick BLAKE, Smørum (DK); Frederik Bruun HJORT, Copenhagen NV (DK); Caroline EKELUND, Smørum (DK)

(21) Appl. No.: 19/564,253

(22) Filed: Mar. 12, 2026

(30) Foreign Application Priority Data
Mar. 14, 2025 (EP) 25163713.8

(51) Int. Cl. H04R 25/00

(52) U.S. Cl. CPC H04R 25/30; H04R 25/554; H04R 2225/55; H04R 2420/07

(57) ABSTRACT

Disclosed herein are embodiments of a hearing aid. In certain examples, the hearing aid includes a wireless interface configured to receive a wireless sound signal, and a processor configured to, initialize a silence counter in response to receiving the wireless sound signal, periodically determine a sound level based on the wireless sound signal, in accordance with the sound level being below a level threshold, increase the silence counter, and in accordance with silence counter being equal to or above a silence threshold, reset the silence counter and provide a notification to a user of the hearing aid.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application generally relates to the field of hearing aids.

### SUMMARY

### A Hearing Aid

In an aspect of the present application, embodiments of a hearing aid are disclosed. The hearing aid includes a wireless interface. The wireless interface is configured to receive a wireless sound signal. The hearing aid includes a processor. The processor is configured to initialize a silence counter in response to receiving the wireless sound signal. The processor is configured to periodically determine a sound level based on the wireless sound signal. The processor is configured to, in accordance with the sound level being below a level threshold, increase the silence counter. The processor is configured to, in accordance with silence counter being equal to or above a silence threshold, provide a notification to a user of the hearing aid and reset the silence counter.

Thereby an improved hearing aid may be provided. Embodiments of the disclosure describe a system that detects long periods of silence and notifies users about them and offers options for taking desired actions. Advantageously, the disclosed hearing aids can provide information to a user to know when they are connected to a silent broadcast. In this way, the user can choose to stay subscribed or end the subscription.

For example, public announcements, like gate information at the airport, museums or hospitals, can be streamed to a hearing aid. Devices broadcasting public announcements are not considered standard streaming devices, as these announcements are not continuously streamed. A significant silence period between announcements is typically expected. During these silent periods, the hearing aid is still streaming, which might confuse users who do not realize they are hearing “silence”. This can be a problem if the device's controls work differently when it's streaming versus when it's just using the microphones only.

In some cases, a broadcast might (accidentally) have no sound at all. If a user is subscribed to such a channel, a user can be informed so they can decide what to do next, providing more adaptability for the hearing aid.

It can be advantageous for users to know when they are connected to a silent broadcast. This way, they can choose to stay subscribed or end the subscription, thereby saving battery life and providing more user adjustability. In certain examples, users can be informed through voice alerts in the hearing device, notifications in an app, or voice messages from the app played through the hearing aid.

Moreover, in contrast to previous solutions where the hearing aid user was required to manually terminate the streaming regardless of content availability, embodiments of the disclosed hearing aids introduce an automated termination feature. This feature ensures that the hearing aid will autonomously terminate streaming if no content is detected for a certain time. This can advantageously serve to save battery in the hearing aid since the broadcast stream will be terminate. Furthermore, the hearing aid can advantageously streamline user interaction and optimize system performance by reducing the need for manual intervention in stream management.

The hearing aid can include a wireless interface. The wireless interface may be understood as a wireless receiver. The wireless interface may be understood as a wireless receiver and a wireless transmitter. The wireless interface can be a wireless transceiver. The wireless interface can be configured to receive a wireless signal. The wireless interface can be configured to receive a wireless sound signal.

The wireless interface can be configured to connect to a source of the wireless sound signal. For example, the wireless interface can be configured to connect to a broadcast source. The wireless interface can be configured to maintain a connection to the source of the wireless sound signal. The wireless interface can be configured to remain connected to the source until the connection is terminated. In certain examples, receiving a wireless sound signal can include continuously receiving the wireless sound signal from a source connected to the wireless interface. For example, the wireless interface can be configured to continuously receive a streamed wireless sound signal from a source of the wireless sound signal.

The wireless sound signal can be a wireless signal indicative of a sound. The wireless sounds signal can be a streamed audio signal. The wireless sound signal can be, for example, a broadcast (e.g., communication, connection). The wireless sound signal can be, for example, a wireless broadcast. The wireless sound signal can be, for example, an audio broadcast. As an example, the wireless sound signal may be an Auracast™ sound signal (e.g., a Bluetooth broadcast audio). The wireless sound signal can be a Bluetooth sound signal. The wireless interface can be configured to receive a plurality of wireless sounds sources. The wireless sound signal can be output by a source (e.g., audio source, streaming source, broadcast source).

The hearing aid includes a processor. The processor can be configured to provide one or more processing to the hearing aid.

The processor can be configured to initialize a silence counter. The processor can be configured to initialize a silence counter in response to receiving the wireless sound signal. The processor can be configured to initialize a silence counter in response to the wireless interface connecting to a source of the wireless sound signal. Initializing a silence counter can include setting the silence counter to 0.

A silence counter can be understood as a variable that is increased or decreased to keep track of a particular event or action. For example, a silence counter can be a variable that changes in a sequential series of integers. The silence counter can start at 0 and be increased by 1 during every increase. Therefore, the silence counter can proceed 0, 1, 2, 3, 4, 5, etc.

In certain examples the silence counter is a silence timer. The timer can be increased by time intervals (dt).

The processor can be configured to determine a sound level based on the wireless sound signal. The processor can be configured to determine a sound level based on the received wireless sound signal. The processor can be configured to determine a sound level of the wireless sound signal. The processor can be configured to determine a sound level of the received wireless sound signal.

The processor can be configured to periodically determine a sound level based on the wireless sound signal. The sound level can be, for example, an input level of the received wireless signal (or an electronic signal representative of the wireless sound signal). The sound level can be a numeric representation of the sound level of the wireless sound signal. Different methodologies can be performed to determine a sound level. For example, a logarithm of the root mean square of the sound signal can be used. An example equation is given below.

% Compute the overall signal log RMS

log_rms=10*log10(mean(x(ii).\hat{ }2, 2));

% Compute signal level

dB=log_rms+scale_constant;

% x: A signal with more samples than channels

As used herein, periodically can be understood as an occurrence happening on a regular time interval. For example, the processor periodically determining a sound level can include the processor determining the sound level at a regular time interval. The processor can be configured to periodically determine the sound level while the wireless interface is connected to a source of the wireless sound signal. If the wireless interface is not connected to a source of a wireless sound signal, the processor will not periodically determine the sound level.

In certain examples, a level threshold can be used. The level threshold can be a numeric value of an input level. The level threshold can provide some allowance for minimal sound to be in the wireless sound signal, such as static or the like. The level threshold can be a level where there is clear sound coming from the wireless sound signal. The level can be lower than normal voice but high enough to avoid undesirable sound artifacts. The level threshold may vary depending on the user and the device. In some examples, the level threshold can be 10, 11, 12, 13, 14, 15, 16, 17, 18, 18, or 20 dB. In certain examples, the level threshold can be a value in the range of 10-20 dB.

In certain example hearing aids, the processor is configured to determine whether the sound level is below a level threshold. In certain example hearing aids, the processor is configured to determine whether the sound level is equal to or above a level threshold.

In accordance with the sound level being below a level threshold, the processor can be configured to increase the silence counter. For example, if the wireless sound signal is streaming silence, the sound level can be determined to be below the level threshold.

To increase the silence counter includes increasing the silence counter to the next integer. For example, if the silence counter is at 0, increasing the silence counter can mean to increase the silence counter to 1. Similarly, if the silence counter is at 1, increasing the silence counter can mean to increase the silence counter to 2.

To increase the silence counter can include increasing the silence counter by time interval dt.

In accordance with the sound level being equal to or above the level threshold the processor can be configured to not increase the silence counter. In accordance with the sound level being equal to or above the level threshold the processor can be configured to reset the silence counter.

In certain examples, a silence threshold can be used. The silence threshold can be indicative of how long silence has been occurring. The silence threshold can be indicative of a long period of silence. The silence threshold can be an integer that will be met or exceeded by the silence counter. For example, the silence threshold can be 10, 20, 30, 40, 50, or 100 minutes. The silence threshold can be 9.5, 15.5, 45.5, etc., minutes as examples.

In examples where a silence timer is used, the silence threshold can be 10, 20, 30, 40, 50, or 100 minutes. The silence threshold can be 9.5, 15.5, 45.5 minutes, etc., as examples.

The silence threshold can be set by a user. The hearing aid can be configured to set the silence threshold. The silence threshold can be stored in the hearing aid.

In certain example hearing aids, the processor is configured to determine whether the silence level is below a silence threshold. In certain example hearing aids, the processor is configured to determine whether the silence level is equal to or above a silence threshold.

In accordance with the silence counter being equal to or above a silence threshold, the processor is configured to provide a notification to a user of the hearing aid. The processor can be configured to provide the notification directly to the user. For example, the processor can provide the notification via the hearing aid. The processor can be configured to provide the notification indirectly to the user. For example, the processor can provide the notification via an accessory device, such as a mobile phone. Providing a notification can be understood as providing a signal indicative of notification to the user.

Providing a notification can include providing a flag to an application (e.g., app). The app can be included on an accessory device. The accessory device can then send a message to the hearing aid with the information. The information may include the status of the wireless sound signal (e.g., “stream has been inactive for 30 minutes”) and instructions on what to do (e.g., “to stop streaming, apply a long press”). It may also contain buttons to simplify interaction (e.g., a button in the app to terminate the stream). Additionally, it can include the consequences of terminating the stream (e.g., “If you stop streaming, you might miss important information about your flight”).

The notification can be indicative of the wireless sound signal being silent. The notification can be indicative of the source not providing sound in a wireless sound signal. The first time the processor provides a notification, the notification can be considered an initial (e.g., first) notification.

In accordance with the silence counter not being equal to or above the silence threshold, the processor is configured to not provide a notification to a user of the hearing aid.

In accordance with the sound level being at or above a level threshold, the processor is configured to reset the silence counter. In other words, resetting the silence counter can include setting the silence counter to 0. In accordance with the silence counter not being equal to or above the silence threshold, the processor is configured to not reset the silence counter.

As an example, the wireless interface can receive a wireless sound signal. The wireless sound signal includes audio of a boarding announcement from a source. The processor can initialize the silence counter upon connection to the source. As the wireless sound signal includes audio, it will be above the level threshold. Therefore, the silence counter will be reset to 0 (even if it is currently at 0). Once the boarding announcement is over, the wireless sound signal would be less than the level threshold, and the processor would increase the silence counter.

In one or more example hearing aids, the processor is configured to periodically determine the sound level every half-second. In one or more example hearing aids, the processor is configured to determine the sound level upon receiving the wireless sound signal (e.g., upon initialization of the sound signal. In one or more example hearing aids, the processor is configured to periodically determine the sound level every second. In one or more example hearing aids, the processor is configured to periodically determine the sound level every five seconds. In one or more example hearing aids, the processor is configured to periodically determine the sound level every quarter second.

In one or more example hearing aids, after providing the notification, the processor is configured to initialize a notification counter. In other words, the processor can be configured to provide a first notification before initialization of the notification counter. Initialization of the notification counter can include, for example, resetting the notification counter to zero.

For example, in accordance with silence counter being equal to or above a silence threshold, the processor can be configured to initialize a notification counter. In accordance with silence counter being below a silence threshold, the processor can be configured to not initialize a notification counter.

To increase the notification counter includes increasing the notification counter to the next integer. For example, if the notification counter is at 0, increasing the notification counter can mean to increase the notification counter to 1. Similarly, if the notification counter is at 1, increasing the notification counter can mean to increase the notification counter to 2.

It can be aggravating to a user to receive constant notifications from the hearing aid. In certain example hearing aids, a notification counter can be used to stop and/or delay sending notifications after sending a first (e.g., initial) notification.

In certain example hearing aids, the processor is configured to determine whether the notification counter is below a notification threshold. In certain example hearing aids, the processor is configured to determine whether the notification counter is equal to or above a notification threshold.

In one or more examples hearing aids, in accordance with the notification counter being below a notification threshold, the processor is configured to prevent a second notification from being provided. In one or more examples hearing aids, in accordance with the notification counter being below a notification threshold, the processor is configured to increase the notification counter. In other words, the processor is configured to prevent (e.g., not allow, not provide) a notification for the user. In this way, there is a delay between the notification (e.g., the first notification) and an eventual second notification.

In one or more example hearing aids, in accordance with the notification counter being equal to or above a notification threshold, the processor is configured to provide a second notification to the user and reset the notification counter. The second notification may be the same as the notification. The second notification may be different from the notification. The second notification may be provided in the same manner as the notification. In other words, resetting the notification counter can include setting the notification counter to 0.

In certain example hearing aids, a counter is used (e.g., a notification counter, a silence counter). In certain examples, the counter could be a timer (e.g., a notification timer, a silence timer). The respective timer can update regularly based on particular time period (e.g., minutes, seconds). The silence threshold and/or the notification threshold can be time based (e.g., minutes, seconds) in certain examples utilizing a timer.

In one or more example hearing aids, the notification threshold is ten minutes. The notification threshold is not limiting, and other thresholds can be used. A user can be configured to set the notification threshold. In this way, a user can optimize the hearing aid for their particular notification needs.

In one or more example hearing aids, the hearing aid comprises a level estimator. In one or more example hearing aids, the processor comprises a level estimator. In one or more example hearing aids, the level estimator is configured to determine the sound level based on the wireless sound signal. The processor is then configured to compare the sound level determined by the level estimator with the level threshold.

The level estimator can be a broadcast level estimator. To determine the sound level based on the wireless sound signal can include determining an input level of the wireless sound signal. In certain examples, determining the sound level can include estimating the sound level of the input signal. The input level can be estimated using a broadband level estimator, followed by a calibration constant. This calibration constant can be advantageous in that the estimated level corresponds to the output level of the hearing aid. In certain examples, the level estimator may also include a smoothing stage, such as a low-pass filter, to incorporate not only momentary samples but also past samples. The time constant for this filter can be, for example, 5 seconds.

In one or more example hearing aids, to provide the notification comprises to provide an audio notification. For example, the hearing aid can be configured to output the notification. The hearing aid can be configured to output the notification via the output unit. The audio notification can be, for example, “The connected wireless sound signal is not providing an audible output”. The audio notification can be a beep or a ping.

In one or more example hearing aids, to provide the notification comprises to terminate the wireless sound signal. For example, the hearing aid (e.g., the wireless interface) can be configured to terminate the wireless sound signal. For example, the hearing aid (e.g., the wireless interface) can be configured to terminate a connection to a source of the wireless sound signal. In one or more examples, the processor is configured to provide the notification and terminate a connection with a source of the wireless sound signal. In certain examples, the hearing aid is configured to terminate the wireless sound signal. Termination can include, for example, disconnecting from a wireless source.

In one or more example hearing aids, to provide the notification comprises to provide a data output to an accessory device. An accessory device can be a computer, a tablet, a phone, etc. The processor can be configured to provide the data output to the accessory device, such as via the wireless interface. The accessory device can then provide a visual and/or audio notification to the user.

In one or more example hearing aids, to provide the notification comprises to switch sources of the wireless interface. For example, the wireless interface can be configured to disconnect from a source of the wireless sound signal and connect to a second source of a second wireless sound signal. In one or more examples, the processor is configured to provide the notification and terminate switch sources.

In one or more example hearing aids, the processor is configured to determine the level threshold based on a source of the wireless sound signal. For example, the wireless interface is configured to receive (e.g., obtain) source data from a source of the wireless sound signal. The source data can include one or more of the level threshold and the silence threshold. Accordingly, different sources may have different parameters that can be obtained by the hearing aid.

In one or more example hearing aids, to determine the level threshold based on the source comprises to determine the level threshold based on a type and/or unique ID of the source. In certain examples, the hearing aid can include a memory having a database of types and/or unique IDs of a plurality of sources. Each type and/or unique ID can have a respective level threshold associated with it in the memory. The wireless interface can obtain the type and/or the unique ID from the source. The processor can then compare the obtained type and/or the unique ID and compare it to the database in the memory of the hearing aid. Based on the database, the processor can be configured to determine the threshold.

In some examples, based on the type of source (e.g., broadcaster, public, emergency) or if it is a known source, the processor could apply a different silence counter based on previous silence detected for the same source. Furthermore, once it is known the average silence time of a similar type of source or an already known source, the processor can inform the hearing aid user the expected silence time, so the user is aware of the silence period for that source.

In addition, if the silence counter was reset because the public broadcast source sent an announcement after a long pause, the processor could save the announcements in an accessory device (as voice or/and text) and be configured to provide the option of repeating the messages. This may be advantageous when the hearing aid user was not fully focused on the streaming contents thus avoiding missing the message.

In certain examples, when the hearing aid is connected to a public broadcast source, the processor could also offer the possibility of automatically activating another source, such as tinnitus sound based or another streaming source once a relative long pause is detected. Then, when a message is received, the processor can deactivate the new source and reproduce the message of the public broadcast source.

In one or more example hearing aids, the hearing aid can be configured to provide source data to an accessory device. The source data can be indicative of available broadcasting sources. The available broadcasting sources can be understood as broadcasting sources that the hearing aid could wirelessly connect (e.g., communicate) with. In one or more example hearing aids, the source data is indicative of greater than six available broadcasting sources. In one or more example hearing aids, the source data is indicative of less than twenty available broadcasting sources. In one or more example hearing aids, the source data is indicative of between six and twenty available broadcasting sources.

The accessory device can be configured to provide (e.g., output, display), based on the source data, the available broadcasting sources (e.g., to a user). For example, the accessory device can be a cellular telephone having a screen and configured to displayed, based on the source data, the available broadcasting sources.

Currently, the list of nearby available broadcasting sources can be displayed as a maximum of 6 items. In environments with high broadcast density, such as busy locations like airports (with more than, for example, six gates), users may struggle to find the broadcast they are interested in. Disclosed herein are embodiments of accessory devices which can be configured to receive the source data. The accessory device can be configured to output available broadcasting sources based on the source data.

In one or more example accessory devices, the accessory device can be configured to receive user input indicative of an order of the broadcasting sources. The accessory device, based on the user input, can change (e.g., adjust) an order of the broadcasting sources. For example, the accessory device can provide (e.g., output, display) a different order of the broadcasting sources based on the user input.

In one or more example accessory devices, the accessory device can be configured to receive user input indicative of a language of the broadcasting sources. The accessory device, based on the user input, can change (e.g., adjust) a language of the broadcasting sources. For example, certain broadcasting sources can provide the same information in different languages. In other words, broadcasting sources may include subgroups (e.g., a single broadcast in different languages). A user can select the language to be output from the broadcasting source.

In one or more example hearing aids, the hearing aid can receive user input indicative of one or more “favorite” broadcasting sources. The hearing aid can be configured to store save data indicative of the one or more “favorite” broadcasting sources. In one or more example hearing aids, the hearing aid can continuously scan for the broadcasting sources indicated in the save data. In one or more example hearing aids, in accordance with hearing aid determining that a broadcasting source indicated in the save data is available to connect to, the hearing aid can automatically connect to the broadcasting source.

The hearing aid can include an input unit configured to receive sound from an environment around the hearing aid.

The hearing aid can include an output unit configured to output, based on the sound, a processed audio.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter (e.g., wireless interface) may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aid may comprise antenna and transceiver circuitry (e.g., wireless interface) allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry (e.g., wireless interface) of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The classification unit may be based on or comprise a neural network, e.g. a recurrent neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user.

### A Method

In an aspect, a method for operating a hearing aid is furthermore provided by the present application. The method can include receiving, by a wireless interface of the hearing aid, a wireless sounds signal. The method can include initializing, by a processor of the hearing aid, a silence counter in response to receiving the wireless sound signal. The method can include periodically determining, by the processor, a sound level based on the wireless sound signal. In accordance with the sound level being below a level threshold, the method includes increasing, by the processor, the silence counter. In certain examples, in accordance with the sound level being equal to or above a level threshold, the method includes not increasing, by the processor, the silence counter. In accordance with silence counter being below a silence threshold, the method includes resetting, by the processor, the silence counter and providing, by the processor, a notification to a user of the hearing aid. In certain examples, in accordance with silence counter being equal to or above a silence threshold, the method includes not resetting, by the processor, the silence counter and not providing, by the processor, a notification to a user of the hearing aid.

The method can include connecting, via the wireless interface, to a source of the wireless sound system.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aids.

### A Computer Readable Medium or Data Carrier

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Hearing System

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows an embodiment of a hearing aid according to the present disclosure,

FIG. 2 schematically shows an embodiment of a hearing aid according to the present disclosure, and

FIG. 3 illustrates an embodiment of a method according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

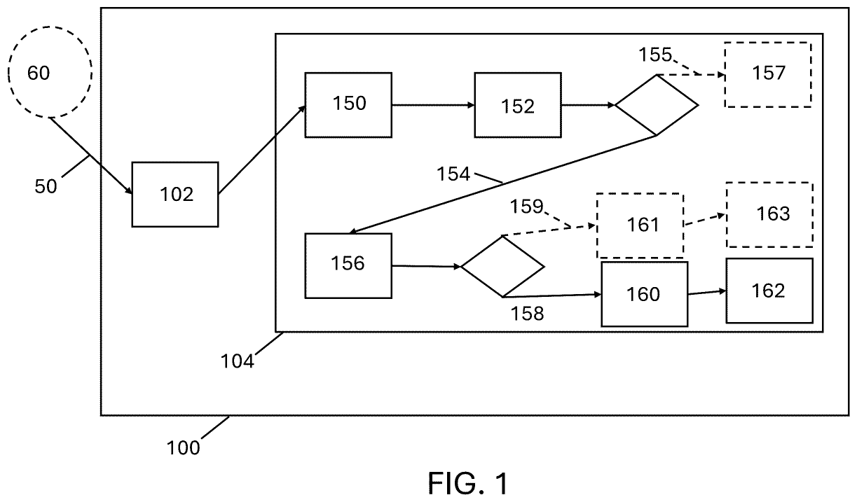

FIG. 1 illustrates a schematic of an example hearing aid according to the disclosure. As shown, the hearing aid 100 can include a wireless interface (e.g., transceiver) 102. The hearing aid 100 can further include a processor 104. The hearing aid 100 can be, for example a behind-the-ear (BTE) hearing aid.

As shown, the hearing aid 100 includes a wireless interface. The wireless interface 102 can be configured to receive a wireless sound signal 50 from a source 60. The source 60 can be, for example, a broadcast source, such as Auracast. The wireless interface 102 can be configured to connect to the source 60.

In response to receiving the wireless sound signal 50, the processor 104 can be configured to initialize 150 a silence counter. The processor 104 can be configured to periodically determine 152 a sound level based on the wireless sound signal 50. The wireless sound signal 50 may be the original signal or may have undergone certain processing. For example, the processor 104 can periodically determine 152 a sound level every half-second.

In accordance with the sound level being below 154 a level threshold, the processor is configured to increase 156 the silence counter. In accordance with the sound level being equal to or above 155 a level threshold, the processor is configured to not increase 157 the silence counter.

In accordance with the silence counter being equal to or above 158 a silence threshold, the processor 104 is configured to reset 160 the silence counter and provide 162 a notification to a user of the hearing aid 100.

In accordance with the silence counter being less than 159 a silence threshold, the processor 104 is configured to not reset 161 the silence counter and not provide 163 a notification to a user of the hearing aid 100.

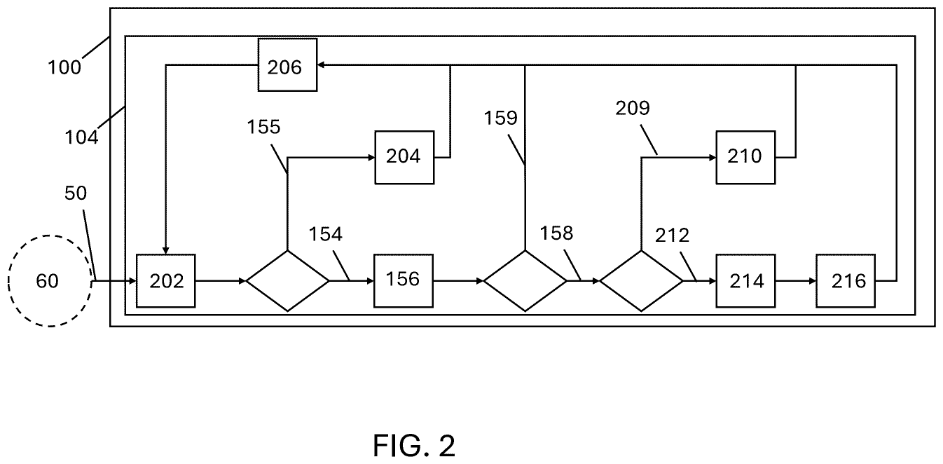

FIG. 2 illustrates a schematic of an example hearing aid according to the disclosure. FIG. 2 provides further details and includes optional elements for hearing aid 100.

For example, the hearing aid 100 can optionally include a level estimator 202. The level estimator 202 can be configured to determine a sound level of the wireless sound signal 50. The level estimator 202 can be part of the processor 104 in certain examples.

If the sound level is equal to or above 155 the level threshold, the processor is configured to reset 204 the silence counter. After time (dt) has elapsed 206 (e.g., the periodic check), the processor re-determines the sound level via level estimator 202.

If the sound level is below 154 a level threshold, the processor 104 is configured to increase 156 the silence counter by time (dt).

If the silence counter is equal to or above 159 a silence threshold, the hearing aid waits for time (dt) 206 to elapse.

If the silence counter is below 158 the silence threshold, the processor 104 is configured to check whether a notification threshold is exceed. If the notification counter is below 209 a notification threshold, the processor 104 is configured to increase 210 the notification counter by time (dt). The hearing aid 210 then allows time (dt) to elapse.

If the notification counter is equal to or above 210 the notification threshold, the processor is configured to provide 214 a notification. The processor 104 can then reset 216 the notification counter.

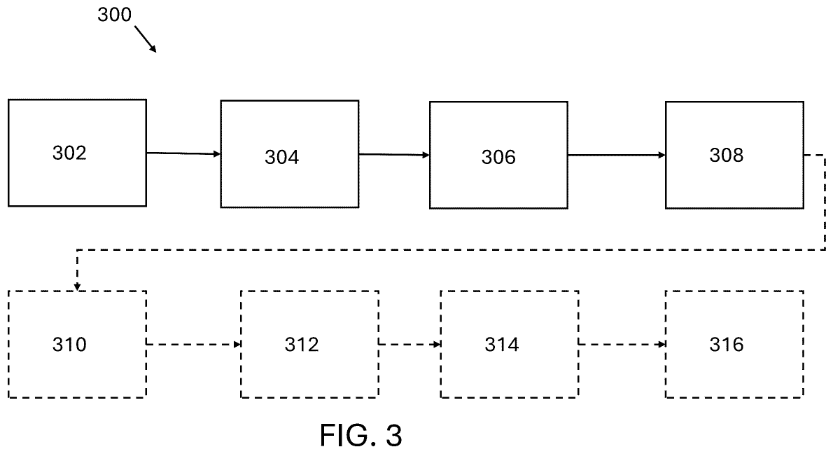

FIG. 3 illustrates an example method according to the disclosure. The method 300 can be performed by a hearing aid.

The method 300 includes receiving 302, via a wireless interface, a wireless sounds signal. The method 300 includes initializing 304, by a processor, a silence counter in response to receiving the wireless sound signal. The method 300 includes periodically determining 306, by the processor, a sound level based on the wireless sound signal. In accordance with the sound level being below a level threshold, the method 300 includes increasing 306, by the processor, the silence counter. In accordance with silence counter being equal to or above a silence threshold, the method 300 includes resetting 308, by the processor, the silence counter and providing 310, by the processor, a notification to a user of the hearing aid.

The method 300 can further include initializing 312, by the processor, a notification counter. In accordance with the notification counter being equal to or above a notification threshold, the method 300 includes providing 314, by the processor, a second notification to the user and resetting 316, by the processor, the notification counter.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising:
a wireless interface configured to receive a wireless sound signal; and
a processor configured to:
initialize a silence counter in response to receiving the wireless sound signal;
periodically determine a sound level based on the wireless sound signal;
in accordance with the sound level being below a level threshold, increase the silence counter; and
in accordance with silence counter being equal to or above a silence threshold, reset the silence counter and provide a notification to a user of the hearing aid;
wherein after providing the notification, the processor is configured to initialize a notification counter;
wherein in accordance with the notification counter being below a notification threshold, the processor is configured to prevent a second notification from being provided; and
wherein in accordance with the notification counter being equal to or above a notification threshold, the processor is configured to provide a second notification to the user and reset the notification counter.

2. The hearing aid of claim 1, wherein the processor is configured to periodically determine the sound level every half-second.

3. The hearing aid of claim 1, wherein the notification threshold is ten minutes.

4. The hearing aid of claim 1, wherein the processor comprises a level estimator, wherein the level estimator is configured to determine the sound level based on the wireless sound signal.

5. The hearing aid of claim 1, wherein to provide the notification comprises to provide an audio notification.

6. The hearing aid of claim 1, wherein to provide the notification comprises to terminate the wireless sound signal.

7. The hearing aid of claim 1, wherein to provide the notification comprises to provide a data output to an accessory device.

8. The hearing aid of claim 1, wherein to provide the notification comprises to switch sources of the wireless interface.

9. The hearing aid of claim 1, wherein the processor is configured to determine the level threshold based on a source of the wireless sound signal.

10. The hearing aid of claim 9, wherein to determine the level threshold based on the source comprises to determine the level threshold based on a type and/or unique ID of the source.

11. The hearing aid of claim 1, wherein the hearing aid is configured to provide source data to an accessory device, wherein the source data is indicative of available broadcasting sources.

12. The hearing aid of claim 11, wherein the source data is indicative of greater than six available broadcasting sources.
